(19) United States
(12) Patent Application Publication
(10) Pub. No.: US 2007/0127631 A1
(43) Pub. Date: Jun. 7, 2007

(54) Method and apparatus for bridging between voicemail and electronic message media types in a communication system

(75) Inventor: Michael G. Difiglia, Jenkintown, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/292,636

(22) Filed: Dec. 2, 2005

(51) Int. Cl. H04M 1/64

(52) U.S. Cl. 379/67.1

(57) ABSTRACT

Method and apparatus for bridging between voicemail and electronic message media types in a communication system. In one example, a voice message is received at a voicemail server in response to an incoming call. Digital audio in the voice message is converted to text data of a text message. An electronic message is formed using the text message. The electronic message is sent using at least one electronic messaging protocol to at least one destination address. The electronic message may comprise a e-mail or an instant message. In one embodiment, a response electronic message is received at the voicemail server. Text data in the response electronic message is converted to digital audio data of a response voice message. An outgoing call is placed to an originator of the incoming call. The response voice message is played in response to the outgoing call being answered.

### BACKGROUND OF THE INVENTION

1. Field of the Invention

The present invention relates to communication systems and, more particularly, to a method and apparatus for bridging between voicemail and electronic message media types in a communication system.

2. Description of the Background Art

Present telephony communication systems are known to include voicemail systems for capturing voice messages when users are not present to receive calls or are otherwise inaccessible. Such voicemail systems include answering machines coupled to specific telephones, local voicemail servers associated with corporate telephony networks and private branch exchanges (PBXs), network voicemail servers in cellular telephone networks, and the like. In some cases, users may be inaccessible to telephones, yet may still have access to electronic mail (e-mail) via a laptop computer, personal data assistant (PDA), and the like. Such users may desire to be aware of incoming voice messages captured by a voicemail system for a home or office phone or cellular telephone. Users may also have the need to respond to such voice messages immediately, without accessing a telephone. Presently, systems exist that will generate notification of events, such as notifying a user that a voice message is waiting. However, such systems do not relay the voice message to the user. Accordingly, there exists a need in the art for relaying voice messages across media types.

### SUMMARY OF THE INVENTION

Method and apparatus for bridging between voicemail and electronic message media types in a communication system. In one embodiment, a voice message is received at a voicemail server in response to an incoming call. Digital audio in the voice message is converted to text data of a text message. An electronic message is formed using the text message. The electronic message is sent using at least one electronic messaging protocol to at least one destination address. The electronic message may comprise a e-mail or an instant message. In one embodiment, a response electronic message is received at the voicemail server. Text data in the response electronic message is converted to digital audio data of a response voice message. An outgoing call is placed to an originator of the incoming call. The response voice message is played in response to the outgoing call being answered.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a communication system constructed in accordance with one or more aspects of the invention;

FIG. 2 is a block diagram depicting an exemplary embodiment of the voicemail server of FIG. 1 in accordance with one or more aspects of the invention;

FIG. 3 is a block diagram depicting an exemplary embodiment of a system for bridging between voicemail and email media types in a communication system in accordance with the invention;

FIG. 4 is a flow diagram depicting an exemplary embodiment of a method for processing a voice message in accordance with one or more aspects of the invention; and

FIG. 5 is a flow diagram depicting an exemplary embodiment of a method for processing a return e-mail in accordance with one or more aspects of the invention.

To facilitate understanding, identical reference numerals have been used, where possible, to designate identical elements that are common to the figures.

### DETAILED DESCRIPTION OF THE INVENTION

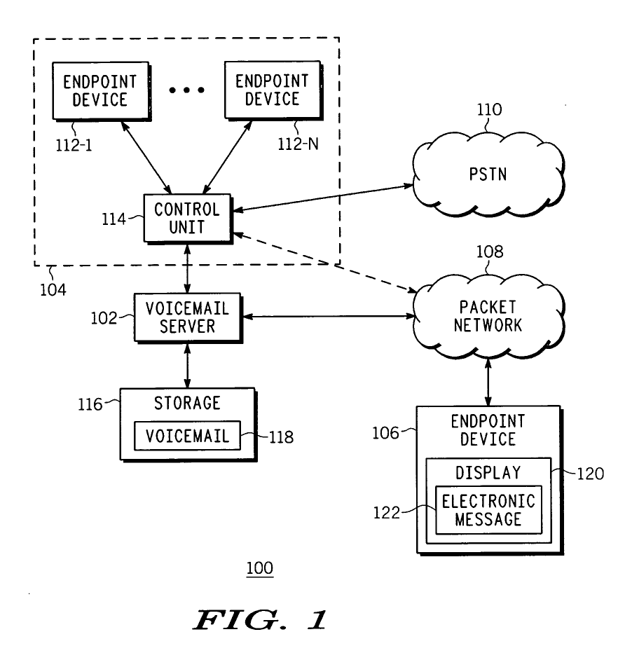

FIG. 1 is a block diagram depicting an exemplary embodiment of a communication system 100 constructed in accordance with one or more aspects of the invention. The system 100 includes a voicemail server 102, a telephony system 104, an endpoint device 106, and a packet network 108. The telephony system 104 processes incoming telephone calls. The incoming calls may be time division multiplexing (TDM)-based calls from a circuit-switched network, such as a publicly switched telephone network (PSTN) 110. Alternatively or in addition to TDM-based calls, the incoming calls may be voice-over internet protocol (VOIP) calls from the packet network 108.

In one embodiment, the telephony system 104 includes a control unit.114 and endpoint devices 112-1 through 112-N (collectively referred to as endpoint devices 112), where N is an integer greater than zero. The control unit 114 is coupled to the PSTN 110 and/or the packet network 108 for receiving the incoming calls. The control unit 114 is further coupled to each of the endpoint devices 112. The control unit 114 processes each incoming call for distribution to one of the endpoint devices 112. For example, the control unit 114 may comprise a private branch exchange (PBX) configured to handle TDM-based and/or VOIP based calls for the endpoint devices 112. The endpoint devices 112 may comprise, for example, telephone terminals.

The control unit 114 is further coupled to the voicemail server 102. The control unit 114 forwards Incoming calls that are not handled by one of the endpoint devices 112 to the voicemail server 102. The control unit 114 typically forwards a given incoming call to the voicemail server 102 after a predefined number of rings for the destination endpoint device. The voicemail server 102 is configured to answer the incoming call and prompt the caller to leave a voice message. The voicemail server 102 typically answers an incoming call with a predefined greeting that requests the caller to leave a voice message. The voicemail server 102 digitally records audio data until the incoming call is terminated by the caller. The voicemail server 102 stores the recorded digital audio data in a storage device 116 as a voice message. The voicemail server 102 may also determine and store the telephone number of the caller. The telephone number of the caller may be determined via caller ID. Such operation of the telephony system 104 and the voicemail server 102 is well known in the art.

In accordance with one embodiment of the invention, the voicemail server 102 is further configured to convert voice messages into text messages and forward the text messages using an electronic messaging protocol to predefined destination addresses. For example, the text messages may be forwarded as electronic mail (e-mail) to predefined e-mail addresses. Alternatively, or in addition to e-mail, the text messages may be forwarded as an “instant messages” to predefined handles (i.e., user names) registered with an instant message (IM) service. The voicemail server 102 is configured with user preferences 124. The user preferences 124 include data for each of a plurality of users. For example, the user preferences 124 may include data for N users respectively associated with the endpoint devices 112-1 through 112-N. For a given user, the preference data dictate when and if the user's voice messages should be converted to text, what electronic messaging protocol or protocols should be used, and to what destination address or addresses such text-converted messages should be forwarded.

In operation, the voicemail server 102 may handle a voice message 118 stored in the storage device 116 associated with a particular user in accordance with the user's preferences. The voicemail server 102 converts the voice message 118 into a text message having a human-readable format, such as a text file, hypertext markup language (HTML) file, or like type format known in the art. The voicemail server 102 may use any commercially available voice-to-text software for the conversion, such as DRAGON Naturally Speaking distributed by Nuance. The voicemail server 102 encapsulates the text message in one or more electronic messages formatted in accordance with the selected electronic messaging protocol(s) and forwards the electronic message(s) to the specified address or addresses via the packet network 108. For example, if an e-mail protocol is selected, the text message may be part of the body of the e-mail or may be a file attached to the email. If a IM protocol is selected, the text message comprises the text of the instant message.

The endpoint device 106 may comprise any type of device capable of receiving and displaying the electronic messages to a user. For example, the endpoint device 106 may comprise a computer, a personal data assistant (PDA), a cellular telephone, or the like. The endpoint device 106 includes a display 120. The endpoint device 106 may be coupled to the packet network 108 to receive electronic messages. For example, the endpoint device 106 may receive and display an electronic message 122 that includes the text representation of the voice message 118. In this manner, a user is not only aware that he or she has a voice message, but can actually read a textual representation of the audio content of the voice message.

In one embodiment of the invention, the voicemail server 102 is further configured to receive response electronic messages from the packet network 108 associated with voice messages stored in the storage device 116. For example, having read the electronic message 122, a user may send a response electronic message to the voicemail server 102. The response electronic message may comprise a response e-mail or a response instant message. Thus, the voicemail server 102 may be configured with a predefined e-mail address and/or predefined handle in an IM service. The voicemail server 102 converts the text of the response electronic message into a digital audio representation. The voicemail server 102 may use any commercially available software for converting text-to-speech, such as ReadPhase by the ReadPhase Corporation or TextSpeed Pro by Digital Future. The voicemail server 102 is configured to signal the control unit 114 to place an outgoing call to the originator of the voice message 118. If the outgoing call is answered, the voicemail server 102 plays the digital audio representation of the return electronic message.

Those skilled in the art will appreciate that the invention may be used in communication systems having other configurations. For example, the system may include a single endpoint coupled to an answering machine. Alternatively, the system may be a cellular telephone system, where the endpoints are cellular phones and the voicemail server is located in the network.

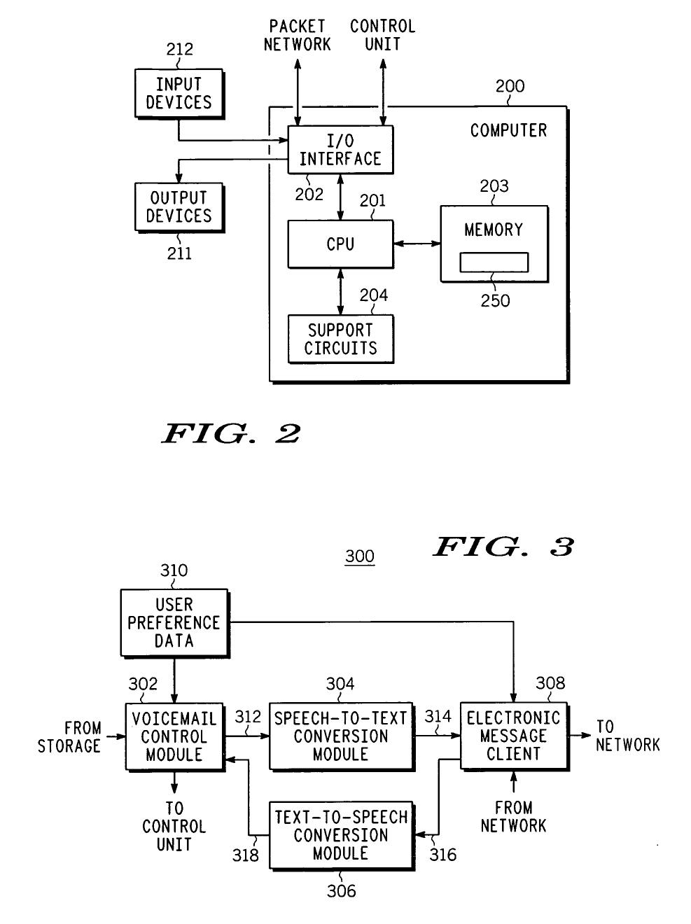

FIG. 2 is a block diagram depicting an exemplary embodiment of the voicemail server 102 in accordance with one or more aspects of the invention. The voicemail server 102 includes a central processing unit (CPU) 201, a memory 203, various support circuits 204, and an I/O interface 202. The CPU 201 may be any type of processor or microprocessor known in the art. The support circuits 204 for the CPU 201 include conventional cache, power supplies, clock circuits, data registers, 1/O interfaces, and the like. The I/O interface 202 may be directly coupled to the memory 203 or coupled through the CPU 201. The I/O interface 202 may be coupled to various input devices 212 and output devices 211, such as a conventional keyboard, mouse, printer, display, and the like. The I/O interface 202 is further configured to communicate with the packet network 108 and the control unit 114.

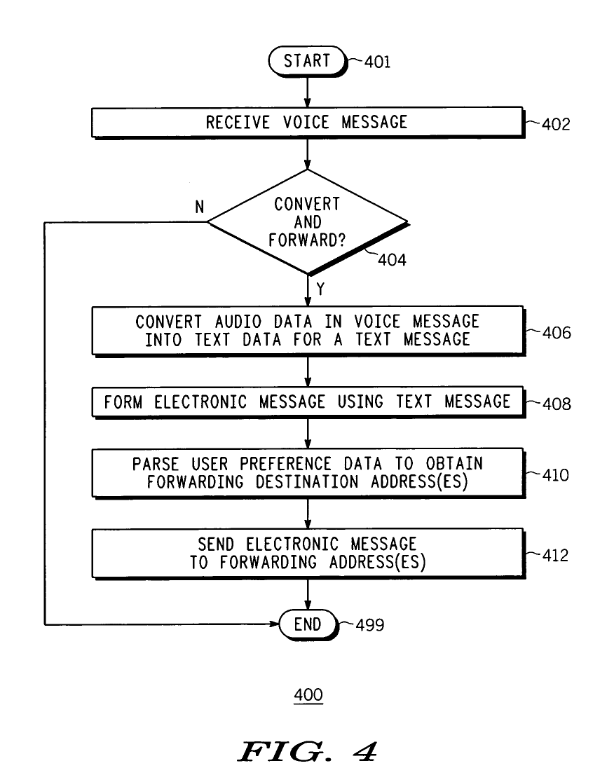

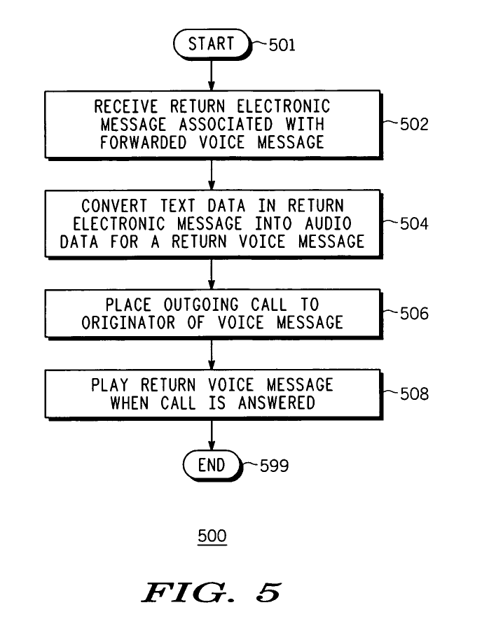

The memory 203 may store all or portions of one or more programs and/or data to implement the processes and methods described herein. Notably, the memory 203 may store software 250 for implementing the system 300 of FIG. 3 and the methods 400 and 500 of FIGS. 4 and 5, respectively, described below. Although one or more aspects of the invention are disclosed as being implemented as a computer executing a software program, those skilled in the art will appreciate that the invention may be implemented in hardware, software, or a combination of hardware and software. Such implementations may include a number of processors independently executing various programs and dedicated hardware, such as ASICs.

The computer 200 may be programmed with an operating system, which may be OS/2, Java Virtual Machine, Linux, Solaris, Unix, Windows, Windows95, Windows98, Windows NT, and Windows2000, WindowsME, and WindowsXP, among other known platforms. At least a portion of an operating system may be disposed in the memory 203. The memory 203 may include one or more of the following random access memory, read only memory, magneto-resistive read/write memory, optical read/write memory, cache memory, magnetic read/write memory, and the like, as well as signal-bearing media as described below.

An aspect of the invention is implemented as a program product for use with a computer system. Program(s) of the program product defines functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

FIG. 3 is a block diagram depicting an exemplary embodiment of a system 300 for bridging between voicemail and electronic message media types in a communication system in accordance with the invention. The system 300 is implemented by the voicemail server 102. The system 300 comprises a voicemail control module 302, a speech-to-text conversion module 304, a text-to-speech conversion module 306, and an electronic message client 308. The voicemail control module 302 is configured to receive user preference data 310. The voicemail control module 302 uses the user preference data 310 to determine if and when a voice message should be forwarded. Responsive to the user preference data 310, the voicemail control module 302 provides a voice message 312 from storage to the speech-to-text conversion module 304. The speech-to-text conversion module 304 converts the digital audio data of the voice message 312 to text data to provide a text message 314.

The text message 314 is received by the electronic message client 308. The electronic message client 308 is further configured to receive the user preference data 310. The electronic message client 308 is configured to incorporate the text message 314 into an electronic message or messages formatted in accordance with selected electronic messaging protocol(s) (e.g., e-mail, instant message, etc.). The electronic message client 308 determines the selected electronic messaging protocol(s) from the user preference data 310. If an e-mail protocol is selected, the text message 314 may comprise the body of the e-mail or be a file attached to the e-mail. If an IM protocol is selected, the text message may comprise the text of an instant message. The electronic message client 308 determines one or more destination addresses for the electronic message(s) from the user preference data 310. The electronic message client 308 sends the electronic message(s) to the destination address(es) via the packet network 108.

The electronic message client 308 is further configured to receive a return electronic message from the packet network 108. The electronic message client 308 provides a return text message 316 to the text-to-speech conversion module 306. The text-to-speech conversion module 306 converts the text data of the return text message 316 to digital audio data to provide a return voice message 318. The return voice message 318 is received by the voicemail control module 302. The voicemail control module 302 is configured to instruct the control unit 114 to place an outgoing call to the originator of the voice message 312 and play the return voice message 318 if the outgoing call is answered. As described above, the telephone number of the originator of the voice message 312 may be stored when the voice message 312 was captured.

FIG. 4 is a flow diagram depicting an exemplary embodiment of a method 400 for processing a voice message in accordance with one or more aspects of the invention. The method 400 begins at step 401. At step 402, a voice message is received. At step 404, a determination is made whether the voice message is to be converted into text and forwarded based on user defined criteria, such as the time of an incoming call, a caller's identity or phone number, or a designation of a priority level of the call indicated by the caller. The user may also designate all calls to be forwarded as text. If a call is not to be forwarded as text, the method 400 ends at step 499. Otherwise, the method 400 proceeds to step 406. At step 406, audio data in the voice message is converted into text data for a text message. At step 408, an electronic message is formed using the text message. At step 410, user preference data is parsed to obtain one or more forwarding destination addresses. At step 412, the electronic message is sent to the forwarding destination address(es). The method 400 ends at step 499.

FIG. 5 is a flow diagram depicting an exemplary embodiment of a method 500 for processing a return electronic message in accordance with one or more aspects of the invention. The method 500 begins at step 501. At step 502, a return electronic message associated with a forwarded voice message is received. At step 504, text data in the electronic message is converted to audio data for a return voice message. At step 506, an outgoing call is placed to the originator of the voice message. At step 508, the return voice message is played in response to the outgoing call being answered. The method 500 ends at step 599.

While the foregoing is directed to illustrative embodiments of the present invention, other and further embodiments of the invention may be devised without departing from the basic scope thereof, and the scope thereof is determined by the claims that follow.

What is claimed is:

1. A method of bridging between voicemail and electronic message media types in a communication system, comprising:
receiving a voice message at a voicemail server in response to an incoming call;
converting digital audio data in the voice message to text data of a text message;
forming an electronic message using the text message; and
sending the electronic message using at least one electronic messaging protocol to at least one destination address.

2. The method of claim 1, further comprising:
receiving a response electronic message at the voicemail server;
converting text data in the response electronic message to digital audio data of a response voice message;
placing an outgoing call to an originator of the incoming call; and
playing the response voice message in response to the outgoing call being answered.

3. The method of claim 2, further comprising:
storing a telephone number for the incoming call;
wherein the outgoing call is placed to the telephone number.

4. The method of claim 1, wherein the electronic message comprises an e-mail message, the at least one electronic messaging protocol comprises an e-mail protocol, and the at least one destination address comprises at least one e-mail address.

5. The method of claim 4, wherein the text message comprises a body of the e-mail message or a human readable text file attached to the e-mail message.

6. The method of claim 1, wherein the electronic message comprises an instant message, the at least one electronic messaging protocol comprises an instant messaging protocol, and the at least one destination address comprises at least one handle defined within an instant messaging service.

7. The method of claim 1, further comprising:
parsing user preference data to obtain the at least one electronic message protocol and the at least one destination address.

8. Apparatus for bridging between voicemail and electronic message media types in a communication system, comprising:
a voicemail control module for obtaining a voice message corresponding to an incoming call;
a speech-to-text conversion module for converting digital audio data in the voice message to text data of a text message; and
an electronic message client for forming an electronic message using the text message and sending the electronic message using at least one electronic messaging protocol to at least one destination address.

9. The apparatus of claim 8, further comprising:
a text-to-speech conversion module for converting text data in a response electronic message to digital audio data of a response voice message;
wherein the electronic message client is further configured to receive the response electronic message; and
wherein the voicemail control module further configured to cause an outgoing call to be placed to an originator of the incoming call and play the response voice message in response to the outgoing call being answered.

10. The apparatus of claim 9, wherein the outgoing call is placed to a telephone number associated with the voice message.

11. The apparatus of claim 8, wherein the electronic message comprises an e-mail message, the at least one electronic messaging protocol comprises an e-mail protocol, and the at least one destination address comprises at least one e-mail address.

12. The apparatus of claim 11, wherein the text message comprises a body of the e-mail message or a human readable text file attached to the e-mail message.

13. The apparatus of claim 8, wherein the electronic message comprises an instant message, the at least one electronic messaging protocol comprises an instant messaging protocol, and the at least one destination address comprises at least one handle defined within an instant messaging service.

14. The apparatus of claim 8, wherein the e-mail client is further configured to parse user preference data to obtain the at least one electronic message protocol and the at least one destination address.

15. A computer readable medium having stored thereon instructions that, when executed by a processor, cause the processor to perform a method of a method of bridging between voicemail and electronic message media types in a communication system, comprising:
receiving a voice message at a voicemail server in response to an incoming call;
converting digital audio data in the voice message to text data of a text message;
forming an electronic message using the text message; and
sending the electronic message using at least one electronic messaging protocol to at least one destination address.

16. The computer readable medium of claim 1, further comprising:
receiving a response electronic message at the voicemail server;
converting text data in the response electronic message to digital audio data of a response voice message;
placing an outgoing call to an originator of the incoming call; and
playing the response voice message in response to the outgoing call being answered.

17. The computer readable medium of claim 16, further comprising:
storing a telephone number for the incoming call;
wherein the outgoing call is placed to the telephone number.

18. The computer readable medium of claim 15, wherein the electronic message comprises an e-mail message, the at least one electronic messaging protocol comprises an e-mail protocol, and the at least one destination address comprises at least one e-mail address.

19. The computer readable medium of claim 18, wherein the text message comprises a body of the e-mail message or a human readable text file attached to the e-mail message.

20. The computer readable medium of claim 15, wherein the electronic message comprises an instant message, the at least one electronic messaging protocol comprises an instant messaging protocol, and the at least one destination address comprises at least one handle defined within an instant messaging service.
